(19) United States
(12) Patent Application Publication
(10) Pub. No.: US 2014/0007848 A1
(43) Pub. Date: Jan. 9, 2014

(54) USING TORSIONAL ENERGY TO MOVE AN ACTUATOR

(71) Applicants: Christopher J. Pluta, Ithaca, NY (US); Braman C. Wing, Interlaken, NY (US); Franklin R. Smith, Cortland, NY (US)

(72) Inventors: Christopher J. Pluta, Ithaca, NY (US); Braman C. Wing, Interlaken, NY (US); Franklin R. Smith, Cortland, NY (US)

(73) Assignee: BORGWARNER INC., Auburn Hills, MI (US)

(21) Appl. No.: 14/005,843

(22) PCT Filed: Mar. 27, 2012
(86) PCT No.: PCT/US12/30679

§ 371 Date: Sep. 18, 2013

Related U.S. Application Data
(60) Provisional application No. 61/470,599, filed on Apr. 1, 2011.

(51) Int. Cl. F02B 75/04

(52) U.S. Cl. CPC F02B 75/04
USPC 123/48 R

(57) ABSTRACT

An actuator for varying a compression ratio of an engine by varying by the rotary motion of a control shaft coupled to a variable compression ratio device. The actuator comprising: a housing assembly mounted to the engine; a rotor assembly coupled to the control shaft defining at least one vane separating a chamber in the housing assembly into a first chamber and a second chamber, the vane being capable of rotation to shift the relative angular position of the rotor assembly from a first rotational position associated with a first compression ratio to a second rotational position associated with a second compression ratio; and a control valve moveable to a first position in which torsional energy from the control shaft is permitted to rotate the rotor assembly in a direction from the first rotational position toward the second rotational position and to a second position opposite the first position.

### REFERENCE TO RELATED APPLICATIONS

This application claims one or more inventions which were disclosed in Provisional Application No. 61/470,599, filed Apr. 1, 2011, entitled “USING TORSIONAL ENERGY TO MOVE AN ACTUATOR”. The benefit under 35 USC §119(e) of the United States provisional application is hereby claimed, and the aforementioned application is hereby incorporated herein by reference.

### BACKGROUND OF THE INVENTION

1. Field of the Invention

The invention pertains to the field of actuators. More particularly, the invention pertains to using torsional energy to move an actuator.

2. Description of Related Art

In some engines, the compression ratio is varied by mechanically changing the volume of the combustion chamber. For example, in U.S. Pat. No. 7,347,180, the compression ratio is mechanically changed by altering the position of eccentric bearings in contact with a crankshaft. By turning the eccentrics, the vertical position of the bearings are changed so that the upper and lower dead center positions of the pistons are displaced. This mechanical changing in addition to a method of adding a first quantify of fuel to the combustion chamber with exhaust gas and then a second quantity of fuel is added to the chamber with fresh air to set a higher compression ratio set in a compression ignition mode.

In another example, the compression ratio is changed by a device that includes an adjusting arrangement with an eccentric which is mounted in a housing of an internal combustion engine and by means of rotation, controls the position and direction of movement of the adjusting arrangement and a drive for operating the adjusting arrangement including the eccentric. The device for changing the compression ratio includes an adjusting lever that varies the length of a piston rod, the lift of the crankshaft and/or an upper edge of the cylinder in terms of its distance from the center of the crankshaft. An eccentric is mounted in the housing and, by rotation, changes the compression ratio during rotation of the adjusting shaft of the adjusting arrangement.

In U.S. Pat. No. 6,823,824, the compression ratio of an engine is varied by changing the position of the crankshaft relative to the piston through an actuator disposed to a side of the main bearing supporting the crankshaft.

U.S. Pat. No. 7,066,118 discloses a compression ratio changing device which includes a piston inner element, a piston outer element slidably fitted over an outer periphery of the piston inner element for sliding movement in an axial direction and capable of being moved between a lower compression ratio position and a higher compression ratio position, a bulking member capable of being turned about axes of the piston inner and outer elements between a non-bulking position and bulking position; and an actuator for moving the bulking member. The bulking member permits movement of the piston outer element to the lower compression ratio position when it is in the non-bulking position and retains the piston outer element in the higher compression ratio position when it is turned to the bulking position. The actuator is hydraulic actuated.

### SUMMARY OF THE INVENTION

An actuator for an internal combustion engine having a variable compression ratio device with a control shaft is disclosed. The compression ratio of the engine is varied by rotary motion of the control shaft of the variable compression ratio device, combustion impulses from the engine impart torsional energy to the control shaft. The actuator comprising: a housing assembly mounted to the engine; a rotor assembly coupled to the control shaft, coaxially located within the housing assembly, the housing assembly and the rotor assembly defining at least one vane separating a chamber in the housing assembly into a first chamber and a second chamber, the vane being capable of rotation to shift the relative angular position of the housing assembly and the rotor assembly from a first rotational position associated with a first compression ratio to a second rotational position associated with a second compression ratio; a control valve comprising a spool slidably mounted within a bore, the spool having at least two lands separated by a central spindle, and a plurality of check valves; the actuator having a first passage coupling the first chamber to a first port in the bore, and a second passage coupling the second chamber to a second port in the bore, such that when the spool is in a first position the lands of the spool allow fluid flow from the first port to the bore surrounding the central spindle, and torsional energy from the control shaft is permitted to rotate the rotor assembly in a direction from the first rotational position toward the second rotational position, causing fluid from the first chamber to flow through the first passage and the first port, through the bore surrounding the central spindle of the control valve and through the second port to the second passage to the second chamber, a first check valve being arranged to prevent fluid flow in a reverse direction; and such that when the spool is in a second position the lands of the spool allow fluid flow from the second port to the bore surrounding the central spindle, and torsional energy from the control shaft is permitted to rotate the rotor assembly in a direction from the second rotational position toward the first rotational position, causing fluid from the second chamber to flow through the second passage and the second port, through the bore surrounding the central spindle of the control valve and through the first port to the first passage to the first chamber, a second check valve being arranged to prevent fluid flow in a reverse direction; wherein when the spool is in the third position, the passage from the first chamber to the port in the spool is blocked by the second check valve within the control valve and the passage from the second chamber to the port in the control valve is blocked by the first check valve within the control valve.

### BRIEF DESCRIPTION OF THE DRAWING

FIG. 1 shows a schematic of a first embodiment of an actuator shifting to a low compression (locked) position.

FIG. 2 shows a schematic of a first embodiment of an actuator shifting to a high compression position.

FIG. 3 shows a schematic of a first embodiment of an actuator maintaining position.

FIG. 4 shows a schematic of a second embodiment of an actuator maintaining position.

FIG. 5 shows a schematic of a third embodiment of an actuator shifting to a low compression (locked) position.

FIG. 6 shows a schematic of a third embodiment of an actuator shifting to a high compression position.

FIG. 7 shows a schematic of a third embodiment of an actuator maintaining position.

FIG. 8 shows an exploded view of the control valve of the third embodiment.

FIG. 9 shows a schematic of fourth embodiment of an actuator shifting to a low compression (locked) position.

FIG. 10 shows a schematic of fourth embodiment of an actuator shifting to a high compression position.

FIG. 11 shows a schematic of fourth embodiment of an actuator maintaining position.

FIG. 12 shows a schematic of a fifth embodiment of an actuator shifting to a low compression (locked) position.

FIG. 13 shows a schematic of a fifth embodiment of an actuator shifting to a high compression position.

FIG. 14 shows a schematic of a fifth embodiment of an actuator maintaining position.

FIG. 15 shows an exploded view of an actuator of the second embodiment of the present invention.

FIG. 16a shows a schematic of a moving cylinder head variable compression ratio device.

FIG. 16b shows a schematic of an offset multilink rod-crank type variable compression ratio device.

### DETAILED DESCRIPTION OF THE INVENTION

It should be noted that like references numbers are used to indicate the same element in the embodiments of the present invention.

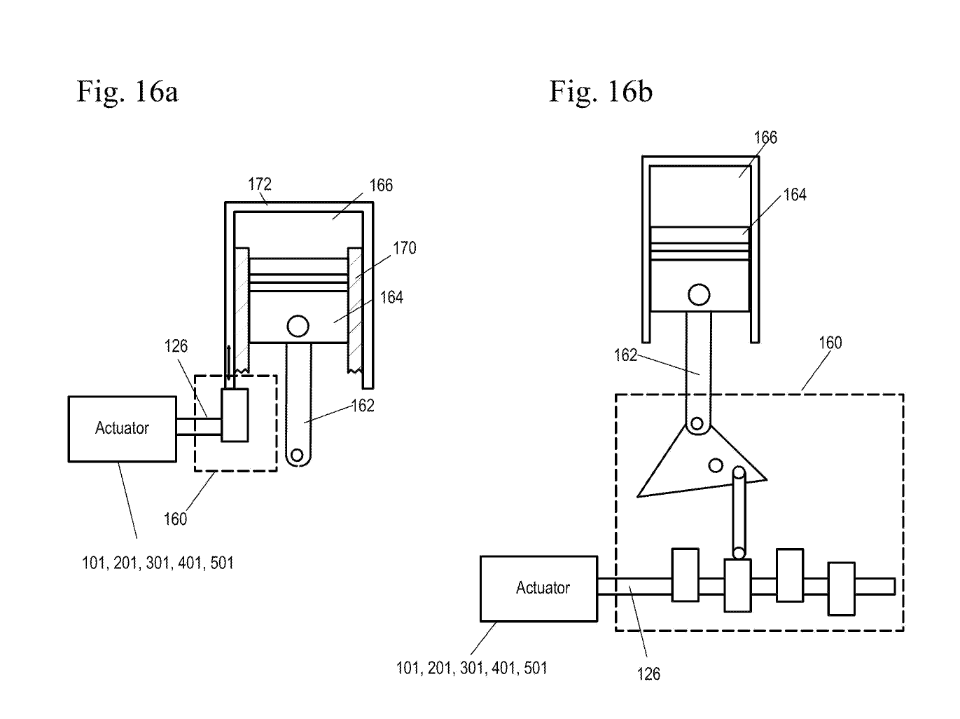

Referring to FIGS. 16a-16b, the embodiments of the present invention include an actuator 101, 201, 301, 401, 501 coupled to a control shaft 126 of a variable compression ratio (VCR) device 160.

FIG. 16a shows a schematic of a moving cylinder head variable compression ratio device 160. In this example, the control shaft 126 moves the cylinder head 172 relative to the stationary cylinder block 170 and the moveable piston 164, altering the size of the combustion chamber 166. The compression ratio of the engine is varied by actuator 101, 201, 301, 401, 501 controlled rotary motion of the control shaft 126 of the VCR device 160 with combustion impulses from the engine imparting torsional energy to the control shaft 126.

FIG. 16b shows a schematic of an offset multilink rod-crank type variable compression ratio device 160 which varies the position of the piston 164 through a control rod 162 to vary the size of the combustion chamber 166 and thus the compression ratio of the engine. In the present invention, the compression ratio of the engine is varied by actuator controlled rotary motion of the control shaft 126 of the VCR device 160 with combustion impulses from the engine imparting torsional energy to the control shaft 126.

FIGS. 16a-16b are just examples of variable compression ratio devices 160 and control shafts 126 that may be used to alter the variable compression ratio of an engine. Other variable compression ratio devices may also be used.

This actuator 101,201, 301, 401 operates similarly to a cam torque (CTA) operated cam phaser. Similar to a cam torque actuated phaser, the actuator 101, 201, 301, 401 is able to use torsional energy to move, acting similar to a hydraulic ratchet. The actuator can function either rotationally or linearly depending on the application.

The positions shown in the figures define the direction the actuator 101, 201, 301, 401, 501 is moving to. It is understood that the control valve 132, 344, 532 has an infinite number of intermediate positions, so that the control valve 132, 344, 532 not only controls the direction the actuator 101, 201, 301, 401, 501 moves but, depending on the discrete spool position, controls the rate at which the actuator 101, 201, 301, 401, 501 changes positions. Therefore, it is understood that the control valve 101, 201, 301, 401, 501 can also operate in infinite intermediate positions and is not limited to the positions shown in the Figures.

The actuator 101, 201, 301, 401, 501 of the present invention has a rotor assembly 105, 405 with one or more vanes 104, 456, mounted to the end or any other place on the control shaft 126, surrounded by a housing assembly 107 with vane chambers into which the vanes fit.

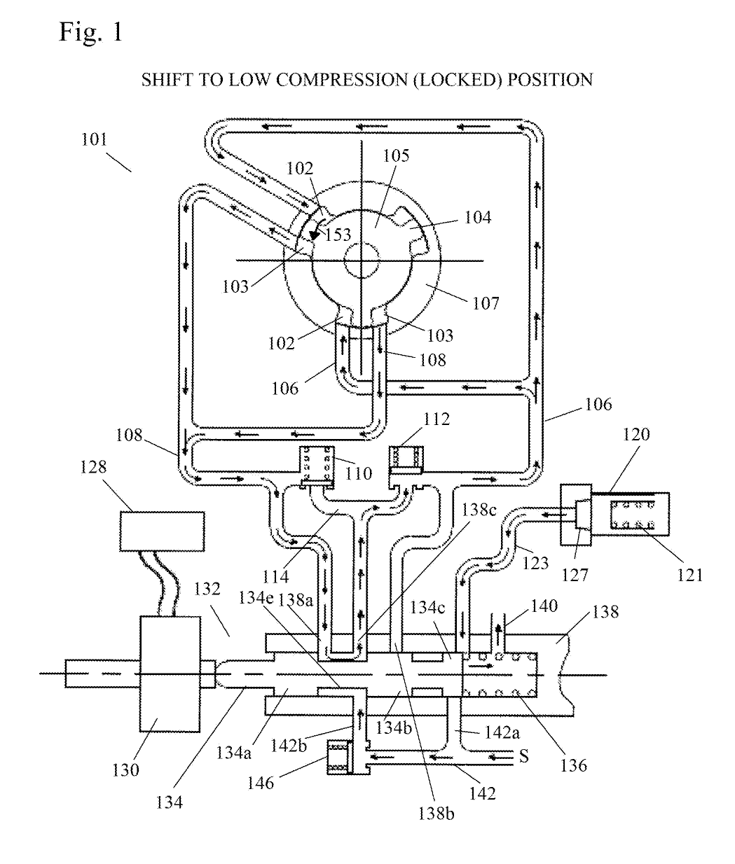

Referring to FIGS. 1-3 of the first embodiment, combustion impulses from the engine imparting torsional energy to the control shaft 126 move the vane 104 through the rotor assembly 105. The first and second chambers 102, 103 are arranged to resist positive and negative torsional energy in the control shaft 126 and are alternatively pressurized by the torsional energy. The positive torsional energy of the control shaft 126 is from the control shaft 126 twisting about its axis in a first direction and the negative torsional energy of the control shaft 126 is from the control shaft 126 twisting about its axis in a direction opposite the first direction.

A control valve 132 allows the vane 104 in the actuator 101 to move by permitting fluid flow from the first chamber 102 to the second chamber 103 or vice versa, depending on the desired direction of movement.

The housing assembly 107 of the actuator 101 is mounted or fixed to the engine and surrounds the rotor assembly 105. Because housing assembly 107 is fixed to the engine, the motion of the housing assembly 107 relative to the engine is restricted. All movement, other than the twisting of the control shaft 126 is done by the rotor assembly 105. The rotor assembly 105 and the vane 104 moves or swings through the distance as defined and limited by the housing assembly 107.

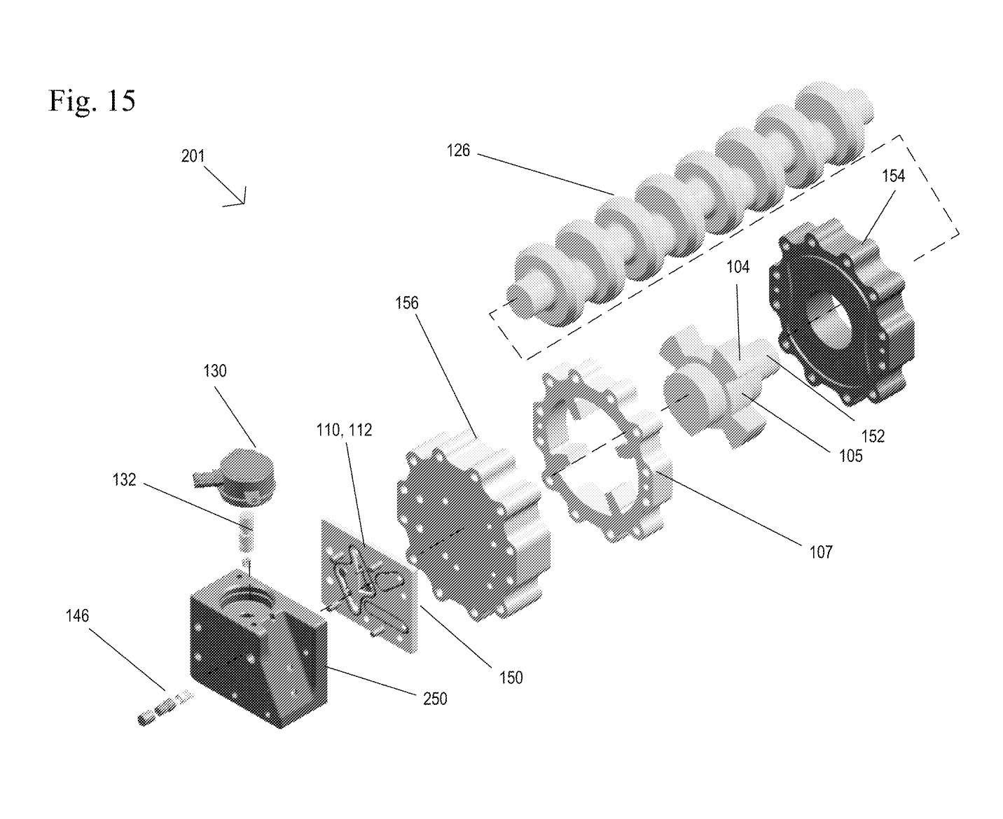

The rotor assembly 105 is connected to the control shaft 126 and is coaxially located within the housing assembly 107. The rotor assembly 105 has a vane 104 separating a chamber formed between the housing assembly 107 and the rotor assembly 105 into a first chamber 102 and a second chamber 103. On either side of the housing assembly 107 is a first endplate (154—see FIG. 15) and a second endplate (156—see FIG. 15), sealing the first 102 and second chambers 103. The vane 104 is capable of rotation to shift the relative angular position of the housing assembly 107 and the rotor assembly 105 from a first rotational position associated with a first compression ratio to a second rotational position associated with a second compression ratio.

The first chambers 102 are connected to a first line 106 which is in fluid communication with a first port 138a of the bore 138 receiving of the control valve 132, the first check valve 112, and a common port 138c in fluid communication with the common line 114. The second chambers 103 are connected to a second line 108 which is in fluid communication with a second port 138b in the bore receiving the control valve 132 and the second check valve 110 leading to a common port 138c in fluid communication with the common line 114.

A lock pin 120 is slidably housed in a bore in the rotor assembly 105 and has an end portion that is biased towards and fits into a recess 127 in the housing assembly 107 by a spring 121. Alternatively, the lock pin 120 may be housed in the housing assembly 107 and be spring 121 biased towards a recess 127 in the rotor assembly 105. In this embodiment, the pressurization of the lock pin 120 is actively controlled by the control valve 132. Alternatively, the lock pin 120 may be passively controlled by supply pressure.

A control valve 132, preferably a spool valve, includes a spool 134 with cylindrical lands 134a, 134b, and 134c separated by a central spindle 134e slidably received in a bore 138 of a sleeve within in the rotor assembly 105. One end of the spool 134 contacts spring 136 and the opposite end of the spool 134 contacts a pulse width modulated variable force solenoid (VFS) 130. The VFS 130 may also be linearly controlled by varying current or voltage or other methods as applicable. Additionally, the opposite end of the spool 134 may contact and be influenced by electromechanical actuators, motors, and on/off solenoids.

The position of the spool 134 is influenced by spring 136 and the VFS 130 controlled by the electronic control unit (ECU) 128. Further detail regarding control of the actuator 101 is discussed in detail below. The position of the spool 134 controls the rotary motion (e.g. to move towards a low compression position, a maintaining position, and a high compression position) of the actuator, and thus the rotary motion of the control shaft 126 of the VCR device 160 and varying the compression ratio. The position of the spool also controls whether the lock pin 120 locks the rotor assembly 105 relative to the housing assembly 107.

Based on the duty cycle of the pulse width modulated variable force solenoid (VFS) 130, the spool 134 moves to a corresponding position along its stroke that corresponds with the shift to low compression position, the maintaining position, and the shift to high compression position, respectively and the lock pin 120 will be pressurized it release or lock the rotor assembly 105 relative to the housing assembly 107. While the FIGS. 1-3 show the control valve 132 in a specific position corresponding to low compression associated with a first compression ratio, high compression associated with a second compression ratio, and maintaining position, other positions of the control valve may be used to achieve the shift to these positions.

FIG. 1 shows the actuator 101 shifting towards the low compression position associated with a first compression ratio. To shift towards the low compression position, the force of the spring 136 is greater than the force of the VFS 130 and the spring 136 moves the spool 134 to the left in the figure until the force of the spring 136 balances the force of the VFS 130. In the low compression position shown, spool land 134b blocks the first port 138a to the first line 106 and the second port 138b to the second line 108 and the common port 138c to the common line 114 are open. Torsional energy or torque pressurizes the second chamber 103, causing fluid to move from the second chamber 103 and into the first chamber 102, and the vane 104 to move in the direction shown by the arrow 153. Fluid exits from the second chamber 103 through second line 108 to the second port 138b of the control valve 132 to the central spindle 134e between spool lands 134a and 134b and recirculates back to the common port 138c in fluid communication with the common line 114, through the first check valve 112 and to the first line 106 leading to the first chamber 102.

Makeup oil is supplied to the actuator from supply S to make up for leakage and enters line 142. Line 142 splits into two lines 142a and 142b. Line 142b leads to an inlet check valve 146 and is in fluid communication with the control valve 132. From the control valve 132, fluid enters common line 114 through the common port 138c and proceeds through either of the check valves 110, 112, depending on which is open to the chambers 102, 103.

Line 142a is in fluid communication with line 123 through the control valve 132. Line 123 in fluid communication with the lock pin 120 and the control valve 132. Fluid is prevented from flowing through line 142a to the lock pin 120 and to line 123 by spool land 134c. Since fluid cannot flow to line 123, the lock pin 120 is no longer pressurized and vents through the spool 134 to sump through exhaust line 140 and the lock pin 120 aligns with recess 127, locking the rotor assembly 105 relative to the housing assembly 107.

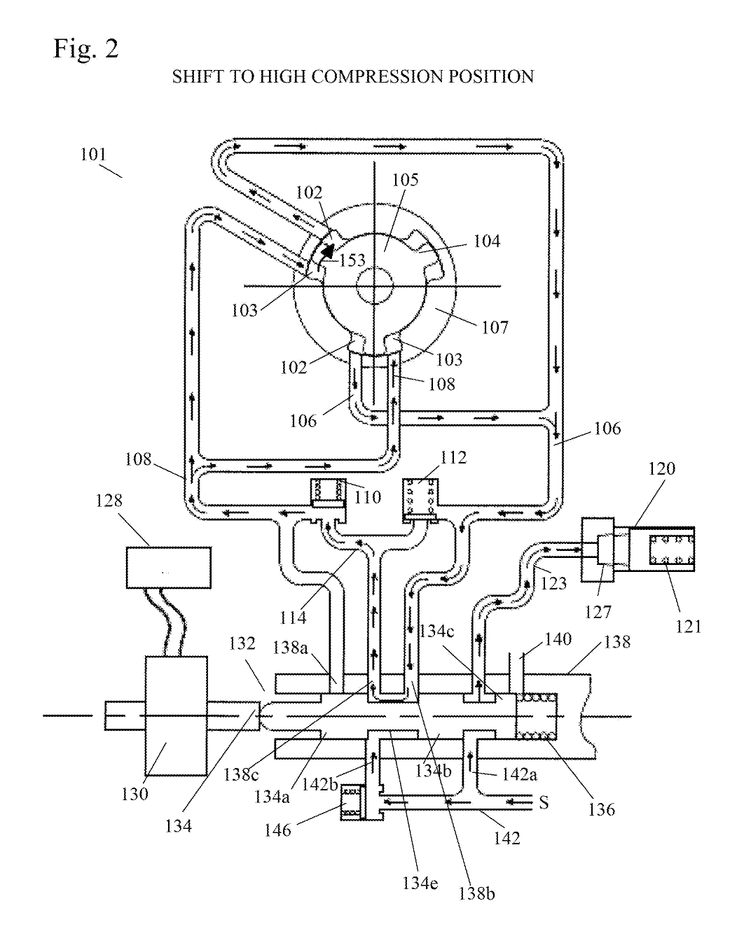

FIG. 2 shows the actuator shifting towards the high compression position associated with a second compression ratio. To shift towards the high compression position, the duty cycle is adjusted so that the force of the VFS 130 on the spool 134 is changed and the spool 134 is moved to the right by the VFS 130 until the force of the spring 136 balances the force of the VFS 130. In the high compression position shown, spool land 134a blocks the second port 138b to the second line 108, and the common port 138c to the common line 114 and the first port 138a to the first line 106 are open. Torsional energy or torque pressurizes the first chamber 102, causing fluid in the first chamber 102 to move into the second chamber 103, and the vane 104 to move in the direction shown by the arrow 153. Fluid exits from the first chamber 102 through first line 106 to the first port 138a of the control valve 132 to the central spindle 134e between spool lands 134a and 134b and recirculates back to the common port 138c of the common line 114, through the second check valve 110 and to the second line 108 leading to the second chamber 103.

Makeup oil is supplied to the actuator from supply S to make up for leakage and enters line 142. Line 142 splits into two lines 142a and 142b. Line 142b leads to an inlet check valve 146 and is in fluid communication with the control valve 132. From the control valve 132, fluid enters common line 114 through the common port 138c and passes through either of the check valves 110, 112, depending on which is open to the chambers 102, 103.

Line 142a is in fluid communication with line 123 through the control valve 132. Line 123 in fluid communication with the lock pin 120 and the control valve 132. The pressure of the fluid in line 142a moves through the spool 134 between lands 134b and 134c to bias the lock pin 120 against the spring 121 to a released position. Exhaust line 140 to sump is blocked by spool land 134c, preventing the lock pin 120 from venting.

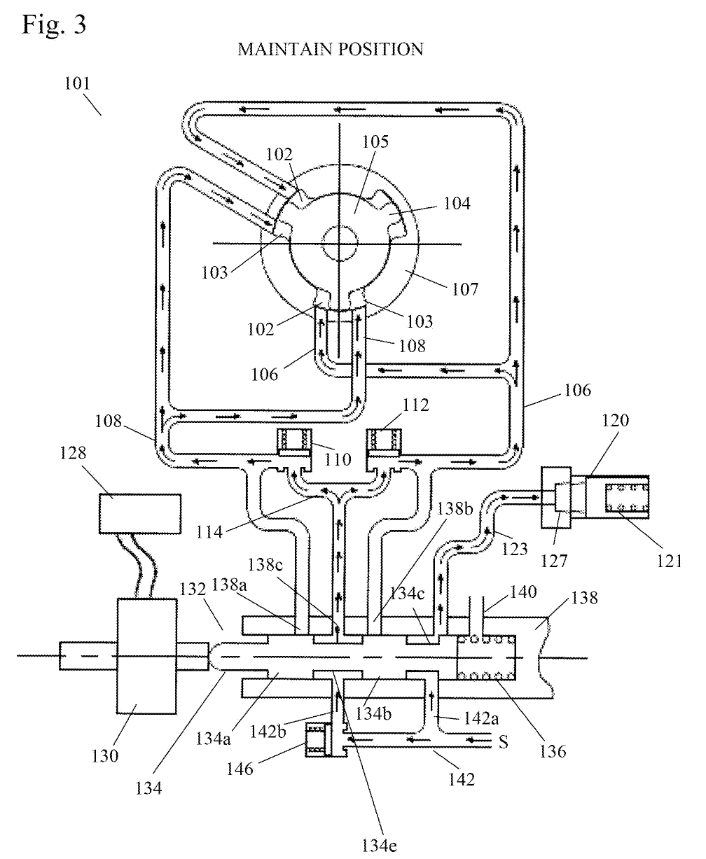

FIG. 3 shows the actuator 101 in the maintaining position, or a position in which the compression ratio is not being altered. In this position, the duty cycle of the variable force solenoid 130 is maintained and the force of the VFS 130 on one end of the spool 134 equals the force of the spring 136 on the opposite end of the spool 134. The lands 134a and 134b block the flow of fluid to the second line 108 through the second port 138b and the first line 106 through the first port 138a respectively. Makeup oil is supplied to the actuator 101 from supply S to make up for leakage and enters line 142. Line 142 splits into two lines 142a and 142b. Line 142b leads to inlet check valve 146 and is in fluid communication the control valve 132. From the control valve 132, fluid enters common line 114 by the common port 138c and passes through either of the check valves 110, 112, depending on which is open to the chambers 102, 103.

Line 142a is in fluid communication with line 123 through the control valve 132. Line 123 is in fluid communication with the lock pin 120 and the control valve 132. The pressure of the fluid in line 142a moves through the spool 134 between lands 134b and 134c to bias the lock pin 120 against the spring 121 to a released position. Exhaust line 140 to sump is blocked by spool land 134c, preventing the lock pin 120 from venting.

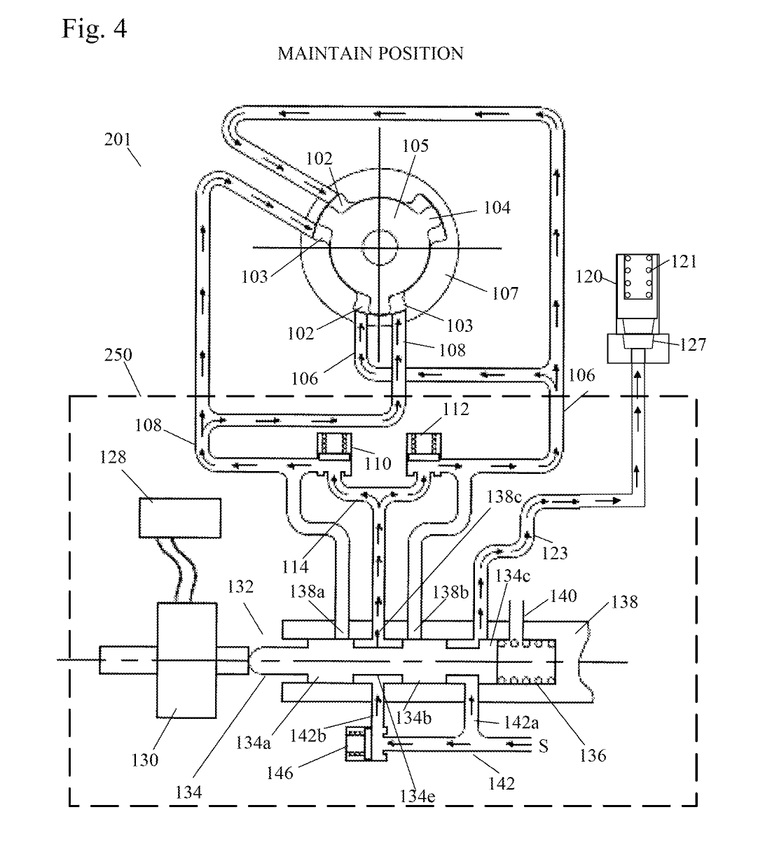

FIG. 4 shows a second embodiment in which a control box 250 (indicated by the dashed line) of the actuator 201 is located remotely from the actuator 201. FIG. 15 shows an exploded view of the actuator 201.

A control box 250 includes the control valve 132, ECU 128 and VFS 130. Attached to the control box 250 is a back plate 150 with check valves 110, 112. The control box 250 is in fluid communication with the actuator 201 through the second line 108, the first line 106, the common line 114 and line 123 to a lock pin 120 located within the actuator 201. The rotor assembly 105 is connected to the control shaft 126 through a stub shaft 152 and is coaxially located within the housing assembly 107. In other embodiments, other connections between the control shaft 126 and the rotor assembly 105 may be used. The shifting of the actuator 201 to a high compression position and a low compression position is as described in FIGS. 1-3 and is herein repeated by reference.

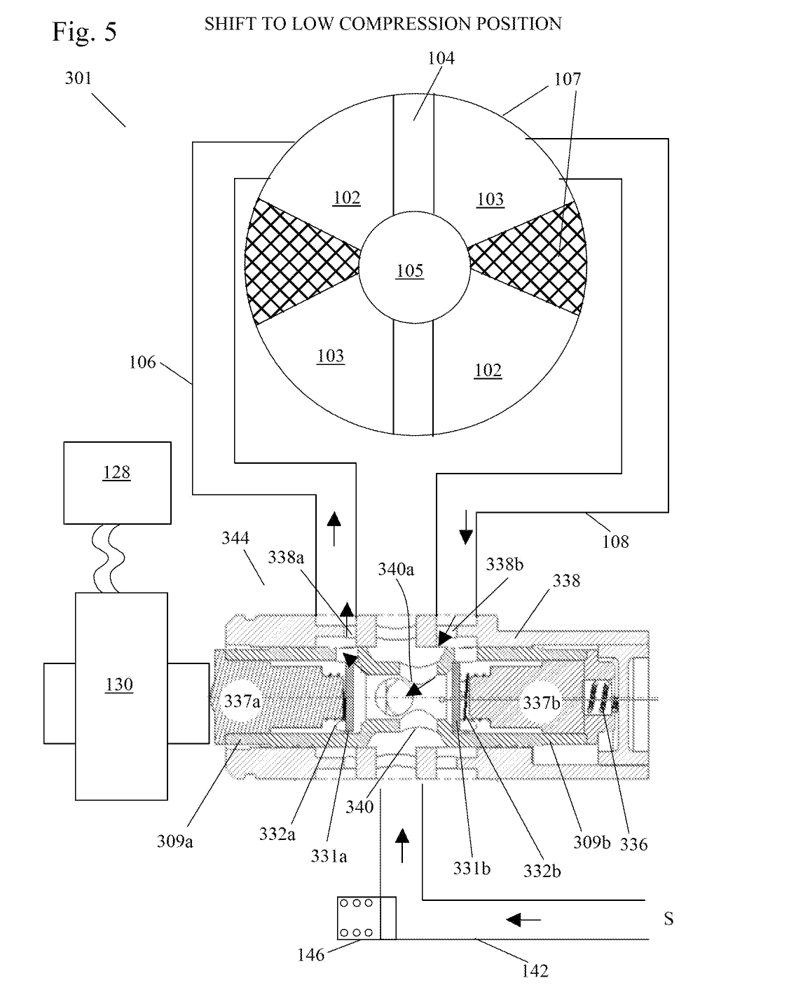

FIGS. 5-8 shows a third embodiment in which the actuator 30 is in the maintaining position and the control valve 344 contains check valves 328a, 328b.

Combustion impulses from the engine imparting torsional energy to the control shaft 126 move the vane 104 through the rotor assembly 105. The first and second chambers 102, 103 are arranged to resist positive and negative torsional energy in the control shaft 126 and are alternatively pressurized by the torsional energy. The positive torsional energy of the control shaft 126 is from the control shaft 126 twisting about its axis in a first direction and the negative torsional energy of the control shaft 126 is from the control shaft 126 twisting about its axis in a direction opposite the first direction.

The rotor assembly 105 which is connected to the control shaft 126 and is coaxially located within the housing assembly 107. The rotor assembly 105 has a vane 104 separating a chamber formed between the housing assembly 107 and the rotor assembly 105 into a first chamber 102 and a second chamber 103. On either side of the housing assembly 107 is a first endplate (154—see FIG. 15) and a second endplate (156—see FIG. 15), sealing the first 102 and second chambers 103. The vane 104 is capable of rotation to shift the relative angular position of the housing assembly 107 and the rotor assembly 105 from a first rotational position associated with a first compression ratio to a second rotational position associated with a second compression ratio.

The control valve 344 allows the vane 104 in the actuator 301 to move by permitting fluid flow from the first chamber 102 to the second chamber 103 or vice versa, depending on the desired movement.

The housing assembly 107 of the actuator 301 is mounted or fixed to the engine and surrounds the rotor assembly 105. Because housing assembly 107 is fixed to the engine, the motion of the housing assembly 107 relative to the engine is restricted. All movement, other than the twisting of the control shaft 126 is done by the rotor assembly 105. The rotor assembly 105 and the vane 104 moves or swings through the distance as defined and limited by the housing assembly 107.

The rotor assembly 105 is connected to the control shaft 126 and is coaxially located within the housing assembly 107. The rotor assembly 105 has a vane 104 separating a chamber formed between the housing assembly 107 and the rotor assembly 105 into a first chamber 102 and a second chamber 103. The vane 104 is capable of rotation to shift the relative angular position of the housing assembly 107 and the rotor assembly 105 from a first rotational position associated with a first compression ratio to a second rotational position associated with a second compression ratio.

The first chambers 102 are connected to a first line 106 which is in fluid communication with a first port 338a of the bore 338 receiving the control valve 344. The second chambers 103 are connected to a second line 108 which is in fluid communication with a second port 338b of the bore 338 receiving the control valve 344.

A lock pin may be associated with the actuator 301. The lock pin may be actively controlled by adding another land to the control valve 344 or passively using the supply oil pressure.

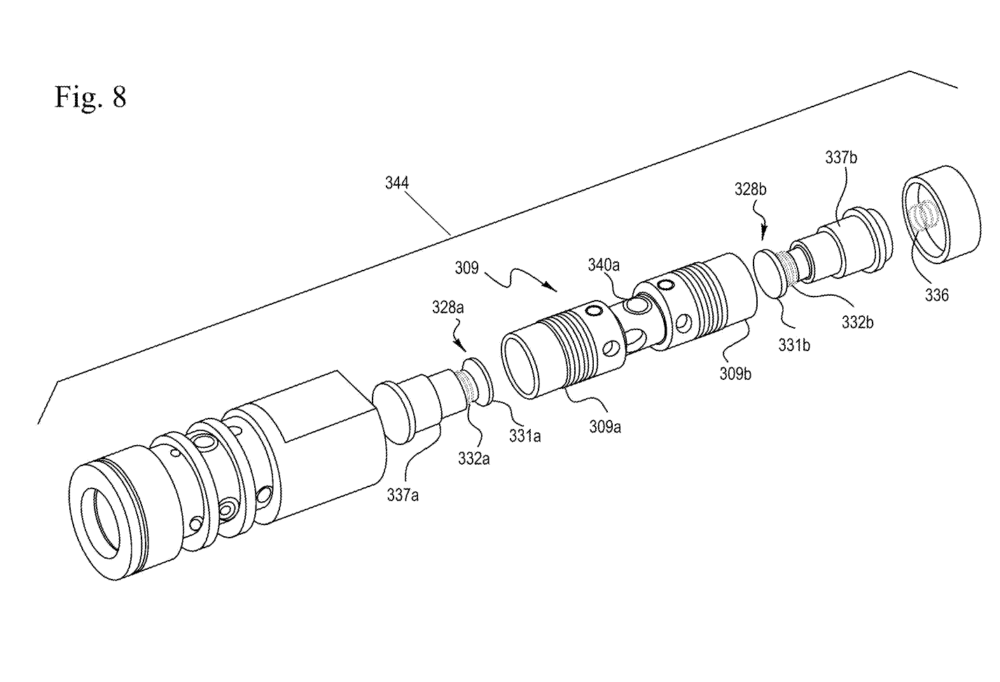

FIG. 8 shows an exploded view of the control valve 344, the control valve 344, preferably a spool valve includes a spool 309 with two lands 309a and 309b separated by a central spindle 340. Within each of the lands 309a and 309b are plugs 337a and 337b that house check valves 328a and 328b. Each check valve 328a, 328b includes a disk 331a, 331b and a spring 332a, 332b. Other types of check valves may be used, including band check valves, ball check valves, and cone-type. The spool 309 is biased outwards from the control shaft by a spring 336. A VFS 130, controlled by an ECU 128, controls the position of the control valve 344.

The position of the control valve 344 controls the rotary motion (e.g. to move towards a low compression position, a maintaining position, and a high compression position) of the actuator, and thus the rotary motion of the control shaft 126 of the VCR device 160 and varying the compression ratio.

Based on the duty cycle of the pulse width modulated variable force solenoid (VFS) 130, the spool 134 moves to a corresponding position along its stroke that corresponds with the shift to low compression position, the maintaining position, and the shift to high compression position. While the FIGS. 5-7 show the control valve 344 in a specific position corresponding to low compression associated with a first compression ratio, high compression associated with a second compression ratio, and maintaining position, other positions of the control valve may be used to achieve the shift to these positions.

FIG. 5 shows the actuator 301 shifting towards the low compression position associated with a first compression ratio. To shift towards the low compression position, the force of the VFS 130 is greater than the force of the spring 336, and the VFS 130 moves the spool to the right in the figure until the force of the VFS 130 balances the force of the spring 336. In the low compression position shown, fluid flows from the second chamber 103 to second port 338b and through the central spindle hole 340a of the central spindle 340, through the first land 309a and the first check valve 328a, through the first port 338a to the first line 106 and the first chamber 102. The second check valve 328b prevents fluid flow in a reverse direction.

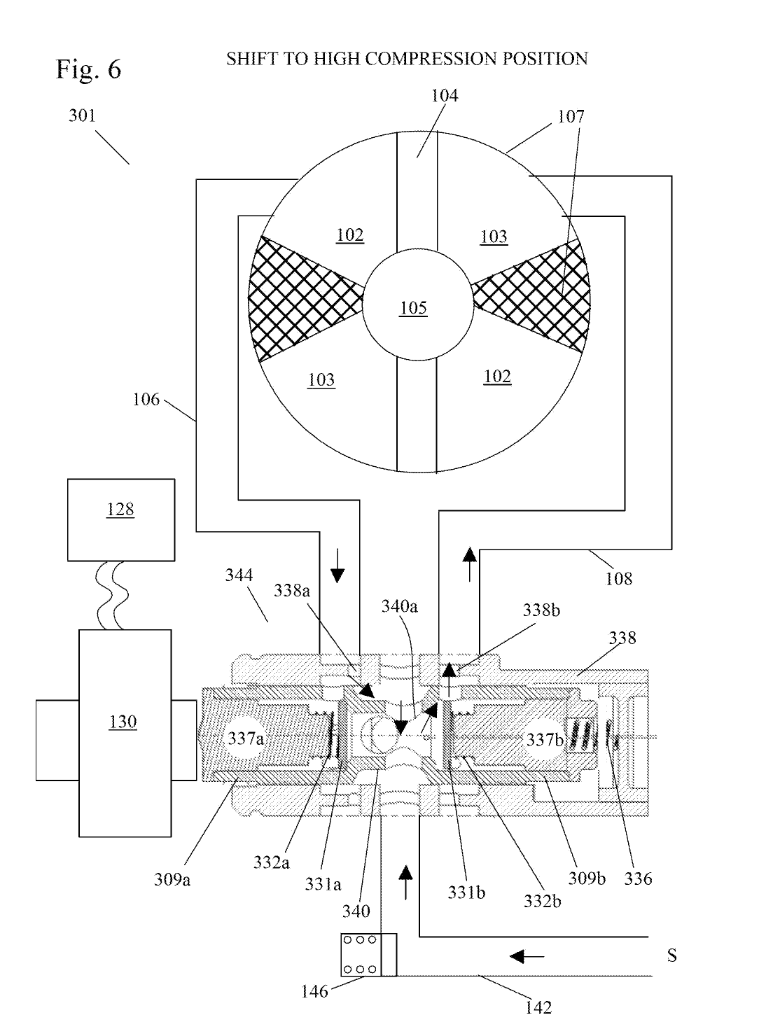

FIG. 6 shows the actuator 301 shifting towards the high compression position associated with a second compression ratio. To shift towards the high compression position, the force of the spring 336 is greater than the force of the VFS 130 and the spring 336 moves the spool to the left in the figure until the force of the spring 336 balances the force of the VFS 130. In the high compression position shown, fluid flows from the first chamber 102 to first port 338a and through the central spindle hole 340a of the central spindle 340, through the second land 309b and the second check valve 328b, through the second port 338b to the second line 108 and the second chamber 103. The first check valve 328a prevents fluid flow in a reverse direction.

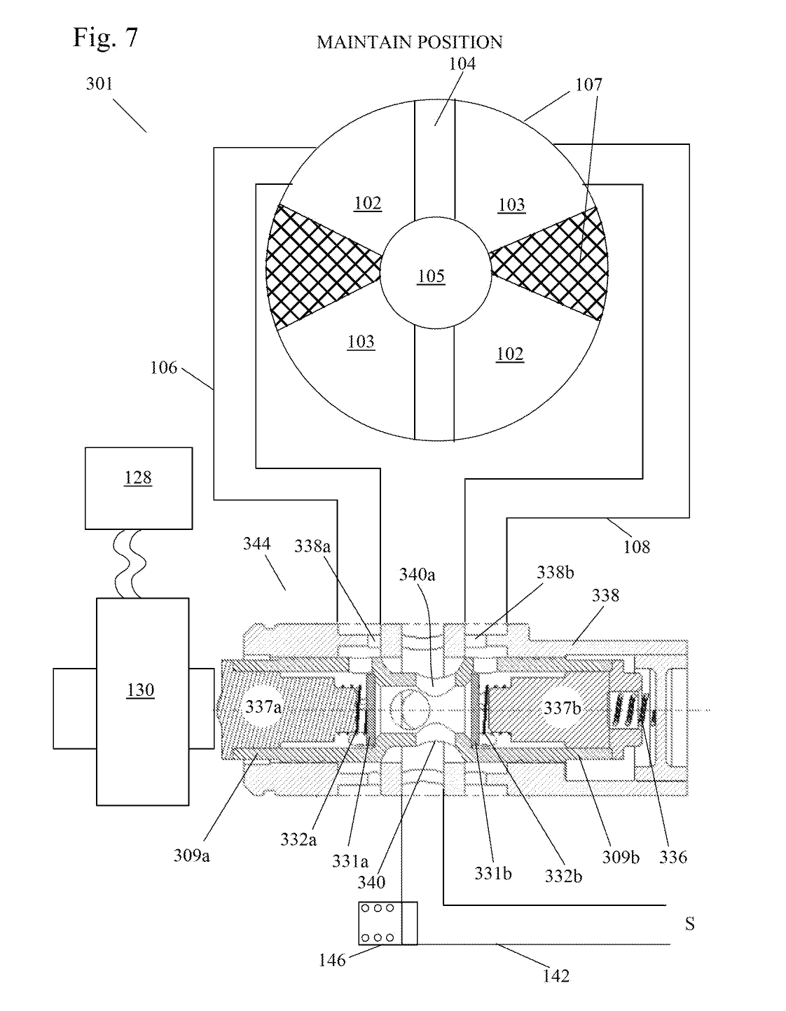

FIG. 7 shows the control valve 344 in the maintaining position. In this position, disks 331a, 331b of check valves 328a, 328b block the exit of the fluid from first and second lines 106, 108 into the central spindle 340 of the control valve 344.

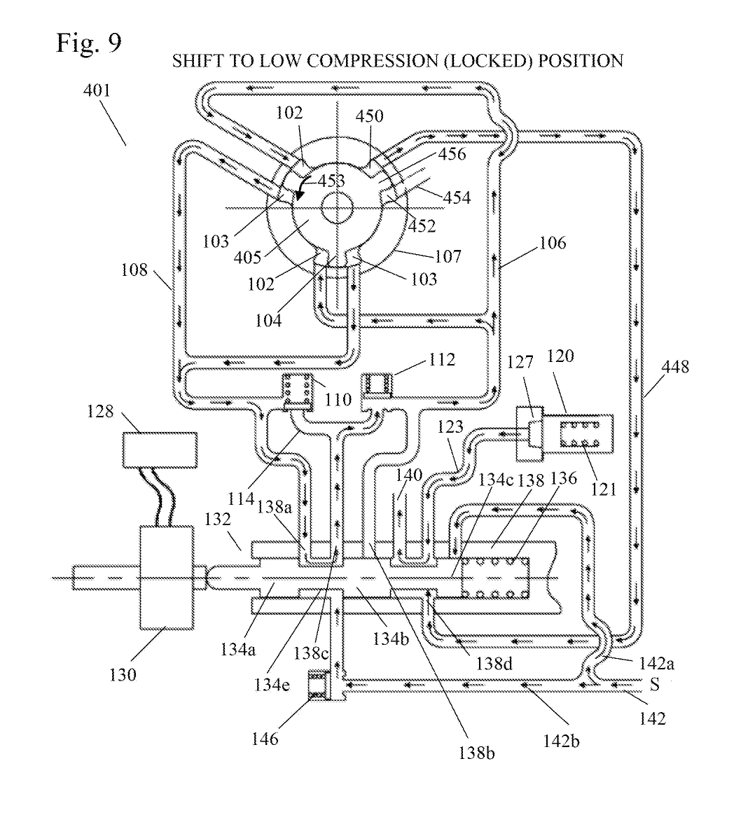

FIGS. 9-11 shows a fourth embodiment of an actuator 401 in which combustion impulses from the engine imparting torsional energy to the control shaft 126 move the vane 104 through the rotor assembly 105. The vanes of the rotor assembly are rotationally moved using both oil pressure and torsional energy from a control shaft 126.

The actuator 401 has a rotor assembly 405 with one or more vanes 104, mounted to the end of the control shaft 126 that are actuated by torsional energy and at least one vane 456 which is actuated by oil pressure. The vanes 104 and rotor assembly 405 are surrounded by a housing assembly 107 with the vane chambers into which the vanes 104, 456 fit. On either side of the housing assembly 107 is a first endplate (154—see FIG. 15) and a second endplate (156—see FIG. 15), sealing the first chambers 102, the second chambers 103, the third chamber 450 and the fourth chamber 452.

The first and second chambers 102, 103 are arranged to resist positive and negative torsional energy in the control shaft 126 and are alternatively pressurized by the torsional energy. The positive torsional energy of the control shaft 126 is from the control shaft 126 twisting about its axis in a first direction and the negative torsional energy of the control shaft 126 is from the control shaft twisting about its axis in a direction opposite the first direction. At least one other vane 456 forms a third chamber 450 which is actuated in one direction by oil pressure from supply S. A fourth chamber 452 on an opposite side of the vane 456 that forms the third chamber 450 is exhausted to sump.

The control valve 132 allows the vane 104 in the actuator 401 to move by permitting fluid flow from the first chamber 102 to the second chamber 103 or vice versa, depending on the desired direction of movement. The control valve 132 also allows vane 456 to move by permitting fluid from supply S to the third chamber 450.

The housing assembly 107 of the actuator 401 is mounted or fixed to the engine and surrounds the rotor assembly 405. Because the housing assembly 107 is fixed to the engine, the motion of the housing assembly 107 relative to the engine is restricted. All movement, other than the twisting of the control shaft 126 is done by the rotor assembly 405. The rotor assembly 405 and the vanes 104, 456 move or swing through the distance as defined and limited by the housing assembly 107.

The rotor assembly 405 is connected to the control shaft 126 and is coaxially located within the housing assembly 107. The rotor assembly 405 has a vane 104 separating a chamber formed between the housing assembly 107 and the rotor assembly 405 into a first chamber 102 and a second chamber 103. The vane 104 is capable of rotation to shift the relative angular position of the housing assembly 107 and the rotor assembly 105 from a first rotational position associated with a first compression ratio to a second rotational position associated with a second compression ratio. The rotor assembly 405 also has a vane 456 separating a chamber formed between the housing assembly 107 and the rotor assembly 405 into a fourth chamber 452 which is exhausted to sump through line 452 and a third chamber 450 connected to control valve 132 through line 448. The movement of vane 456 aids in moving the rotor assembly 405 in one direction only.

The first chambers 102 are connected to a first line 106 which is in fluid communication with a first port 138a of the bore 138 receiving the control valve 132, the first check valve 112, and a common port 138c in fluid communication with the common line 114. The second chambers 103 are connected to a second line 108 which is in fluid communication with a second port 138b in the bore receiving the control valve 132 and the second check valve 110 leading to a common port 138c in fluid communication with the common line 114. The third chamber 450 is in fluid communication with a fourth port 138d of the bore 138 receiving the control valve 132 which receives oil pressure from an inlet line 142a or a line 140 leading to sump. The fourth chamber 452 is always exhausted to sump through line 454.

A lock pin 120 is slidably housed in a bore in the rotor assembly 405 and has an end portion that is biased towards and fits into a recess 127 in the housing assembly 107 by a spring 121. Alternatively, the lock pin 120 may be housed in the housing assembly 107 and be spring 121 biased towards a recess 127 in the rotor assembly 405. The pressurization of the lock pin 120 is actively controlled by the movement of the control valve 132.

A control valve 132, preferably a spool valve, includes a spool 134 with cylindrical lands 134a, 134b, and 134c separated by a central spindle 134e slidably received within a bore 138 of the sleeve within the rotor assembly 405. One end of the spool 134 contacts spring 136 and the opposite end of the spool 134 contacts a pulse width modulated variable force solenoid (VFS) 130. The VFS 130 may also be linearly controlled by varying current or voltage or other methods as applicable. Additionally, the opposite end of the spool 134 may contact and be influenced by a motor, electromechanical means, on/off solenoid or other actuators.

The position of the spool 134 is influenced by spring 136 and the VFS 130. The VFS 130 is controlled by the ECU 128. Further detail regarding control of the actuator 401 is discussed in detail below. The position of the spool 134 controls the rotary motion (e.g. to move towards a low compression position, a maintaining position, and a high compression position) of the actuator, and thus the rotary motion of the control shaft 126 of the VCR device 160 and varying the compression ratio. The position of the spool also controls whether the lock pin 120 locks the rotor assembly 105 relative to the housing assembly 107.

Based on the duty cycle of the pulse width modulated variable force solenoid 130, the spool 134 moves to a corresponding position along its stroke that corresponds with the shift to low compression position, the maintaining position, and the shift to high compression position, respectively and the lock pin 120 will be pressurized to release or to lock the rotor assembly 405 relative to the housing assembly 107. While the FIGS. 9-11 show the control valve 132 in a specific position corresponding to low compression, high compression and maintaining position, other positions of the control valve 132 may be used to achieve the shift to these positions.

FIG. 9 shows the actuator 401 shifting towards the low compression position associated with a first compression ratio. To shift towards the low compression position, the force of the spring 136 is greater than the force of the VFS 130 and the spring moves the spool 134 to the left in the figure until the force of the spring 136 balances the force of the VFS 130. In the low compression position shown, spool land 134b blocks the first port 138a to the first line 106 and second port 138b to the second line 108 and the common port 138c to the common line 114 are open. Torsional energy or torque pressurizes the second chamber 103, causing fluid to move from the second chamber 103 and into the first chamber 102, and the vane 104 to move in the direction shown by the arrow 453. Fluid exits from the second chamber 103 through second line 108 to the second port 138b of the control valve 132 to the central spindle 134e between spool lands 134a and 134b and recirculates back to the common port 138c in fluid communication with the common line 114 through the first check valve 112 and the first line 106 leading to the first chamber 102. At the same time, fluid exhausts from the oil pressure actuated third chamber 450 to the control valve 132 between spool land 134b and 134c and exhausts to sump through line 440. Fluid is also exhausted to sump through line 454 from the fourth chamber 452.

Makeup oil is supplied to the actuator from supply S to make up for leakage and enters line 142. Line 142 splits into two lines 142a and 142b. Line 142b leads to an inlet check valve 146 and the control valve 132. From the control valve 132, fluid enters common line 114 through common port 138c and flows through either of the check valves 110, 112, depending on which is open to the chambers 102, 103.

Line 142a is in fluid communication with line 123 through the control valve 132. Fluid from inlet branch line 142a is blocked by spool land 134c. Fluid is prevented from flowing through line 142a to line 123 leading to the lock pin 120 by spool land 134c. Since fluid cannot flow to line 123, the lock pin 120 is no longer pressurized and vents through the spool 134 to sump through exhaust line 140 and the lock pin 120 aligns with recess 127, locking the rotor assembly 405 relative to the housing assembly 107. Fluid is also prevented from flowing to the oil pressure actuated third chamber 450.

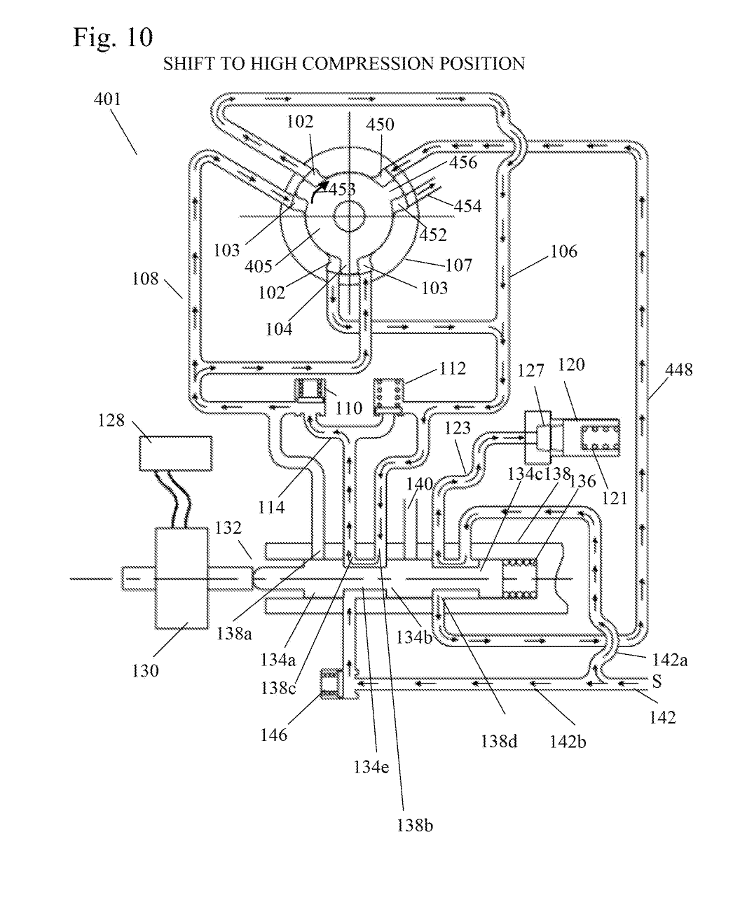

FIG. 10 shows the actuator 401 shifting towards the high compression position associated with a second compression ratio. To shift towards the high compression position, the duty cycle is adjusted so that the force of the VFS 130 on the spool 134 is changed and the spool 134 is moved to the right by the VFS 130 until the force of the spring 136 balances the force of the VFS 130. In the high compression position shown, spool land 134a blocks the second port 138b to the second line 108, and the common port 138c to the common line 114 and the first port 138a to the first line 106 are open. Torsional energy or torque pressurizes the first chamber 102, causing fluid in the first chamber 102 to move into the second chamber 103, and the vane 104 to move in the direction shown by the arrow 153. Fluid exits from the first chamber 102 through first line 106 to the first port 138a of the control valve 132 to the central spindle 134e between spool lands 134a and 134b and recirculates back to the common port 138c of the common line 114, through the second check valve 110 and to the second line 108 leading to the second chamber 103.

Makeup oil is supplied to the actuator from supply S to make up for leakage and enters line 142. Line 142 splits into two lines 142a and 142b. Line 142b leads to an inlet check valve 146 and is in fluid communication with the control valve 132. From the control valve 132, fluid enters common line 114 through the common port 138c and passes through either of the check valves 110, 112, depending on which is open to the chambers 102, 103.

Line 142a is in fluid communication with line 123 through the control valve 132 between spool lands 134b and 134c. The pressure of the fluid in line 142a moves through the spool 134 between lands 134b and 134c to bias the lock pin 125 against the spring 124 to a released position. Exhaust line 140 is blocked by spool land 134c, preventing the lock pin 120 from venting. At the same time, fluid flows to the oil pressure actuated third chamber 450 through line 448 and fluid is exhausted to sump through line 454 from the fourth chamber 452. The fluid supplied to the oil pressure actuated third chamber 450 aids in moving the rotor assembly 405 in the direction of the arrow 453.

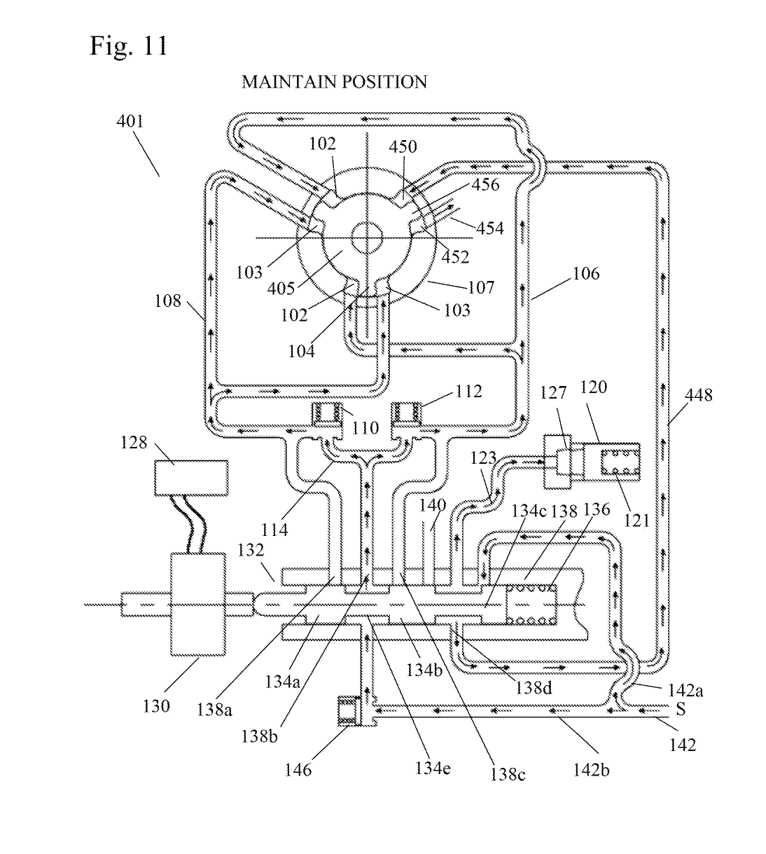

FIG. 11 shows the actuator 401 in the maintaining position. In this position, the duty cycle of the variable force solenoid 130 is maintained, such that the force of the VFS 130 on one end of the spool 134 equals the force of the spring 136 on the opposite end of the spool 134 in maintaining mode. The lands 134a and 134b block the flow of fluid to the second line 108 through the second port 138b and the first line 106 through the first port 138a respectively. Makeup oil is supplied to the phaser from supply S to make up for leakage and enters line 142. Line 142 splits into two lines 142a and 142b. Line 142b leads to inlet check valve 146 and is in fluid communication with the control valve 132. From the control valve 132, fluid enters common line 114 by the common port 138c and passes through either of the check valves 110, 112, depending on which is open to the chambers 102, 103.

Line 142a leads to line 123 and the lock pin 120. The pressure of the fluid in line 142a moves through the spool 134 between lands 134b and 134c to bias the lock pin 120 against the spring 124 to a released position. Exhaust line 140 is blocked by spool land 134c, preventing the lock pin 120 from venting. At the same time, fluid flows to the oil pressure actuated third chamber 450 through line 448 and fluid is exhausted to sump through line 454 from the fourth chamber 452.

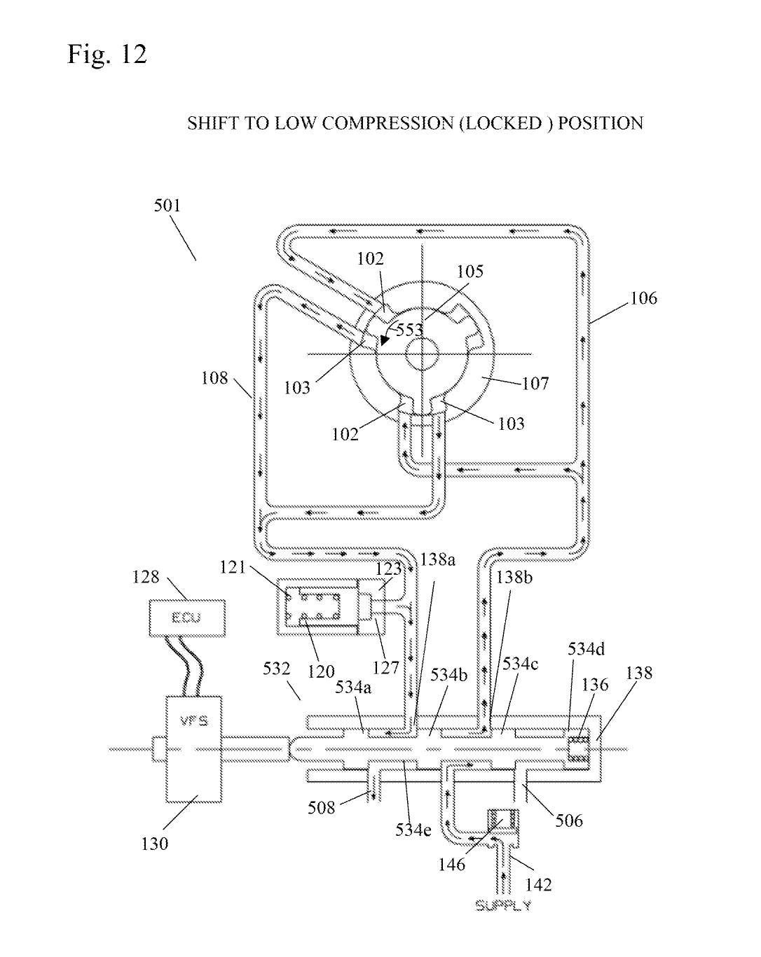

FIGS. 12-14 show an actuator 501 of a fifth embodiment, in which combustion impulses from the engine impart torsional energy to the control shaft 126 move the vane 104 through the rotor assembly 105.

The actuator of the present invention has a rotor assembly 105 with one or more vanes 104, mounted to the end of the control shaft, surrounded by a housing assembly 107 with the vane chambers into which the vanes fit. On either side of the housing assembly 107 is a first endplate (154—see FIG. 15) and a second endplate (156—see FIG. 15), sealing the first 102 and second chambers 103.

The first and second chambers 102, 103 are alternatively pressurized by the torsional energy. The positive torsional energy of the control shaft is from the control shaft 126 twisting about its axis in a first direction and the negative torsional energy of the control shaft 126 is from the control shaft twisting about its axis in a direction opposite the first direction. The vane 104 of the rotor assembly 405 is actuated by oil pressure from supply S.

The control valve 532 allows the vane 104 in the actuator 501 to move by permitting fluid flow to the first chamber 102 and to the second chamber 103, depending on the desired direction of movement. Fluid does not flow from the first chamber 102 to the second chamber 103 or vice versa.

The housing assembly 107 of the actuator 501 is mounted or fixed to the engine and surrounds the rotor assembly 105. Because the housing assembly 107 is fixed to the engine, the motion of the housing assembly 107 relative to the engine is restricted. All movement, other than the twisting of the control shaft 126 is done by the rotor assembly 105. The rotor assembly 105 and the vane 104 moves or swings through the distance as defined and limited by the housing assembly 107.

The rotor assembly 105 is connected to the control shaft 126 and is coaxially located within the housing assembly 107. The rotor assembly 105 has a vane 104 separating a chamber formed between the housing assembly 107 and the rotor assembly 105 into an first chamber 102 and a second chamber 103. The vane 104 is capable of rotation to shift the relative angular position of the housing assembly 107 and the rotor assembly 105 from a first rotational position associated with a first compression ratio to a second rotational position associated with a second compression ratio.

The first chambers 102 are connected to an first line 106 which is in fluid communication with a first port 138 of the bore receiving the control valve 532. The second chambers 103 are connected to a second line 108 which is in fluid communication with a second port 138b of the control valve 532.

A lock pin 120 is slidably housed in a bore in the rotor assembly 105 and has an end portion that is biased towards and fits into a recess 127 in the housing assembly 107 by a spring 121. Alternatively, the lock pin 120 may be housed in the housing assembly 107 and be spring 121 biased towards a recess 127 in the rotor assembly 105. The pressurization of the lock pin 120 is actively controlled by the control valve 532.

A control valve 532, preferably a spool valve, includes a spool 534 with cylindrical lands 534a, 534b, 534c, 534d separated by a central spindle 534e slidably received in a bore 138 of the sleeve within the rotor assembly 105. One end of the spool 534 contacts spring 136 and the opposite end of the spool 534 contacts a pulse width modulated variable force solenoid (VFS) 130. The VFS 130 may also be linearly controlled by varying current or voltage or other methods as applicable. Additionally, the opposite end of the spool 534 may contact and be influenced by electromechanical actuators, motors, and on/off solenoids or other actuators.

The position of the spool 534 is influenced by spring 136 and the VFS 130 controlled by the electronic control unit (ECU) 128. Further detail regarding control of the actuator 501 is discussed in detail below. The position of the spool 534 controls the rotary motion (e.g. to move towards a low compression position, a maintaining position, and a high compression position) of the actuator and thus the rotary motion of the control shaft 126 of the VCR device 160 and varying the compression ratio The position of the spool also controls whether the lock pin 120 locks the rotor assembly 105 relative to the housing assembly 107.

Based on the duty cycle of the pulse width modulated variable force solenoid 130, the spool 534 moves to a corresponding position along its stroke that corresponds with the shift to low compression position, the maintaining position, and the shift to high compression position, respectively and the lock pin 120 will be pressurized to release or lock the rotor assembly 105 relative to the housing assembly 107. While the FIGS. 10-12 show the control valve in a specific position corresponding to low compression, high compression and maintaining position, other positions of the control valve may be used to achieve the shift to these positions.

FIG. 12 shows the actuator 501 shifting towards the low compression position associated with a first compression ratio. To shift towards the low compression position, the force of the VFS 130 is greater than the force of the spring 136 and the VFS 130 moves the spool 534 to the right in the figure until the force of the VFS 130 balances the force of the spring 136. In the low compression position shown, fluid is supplied from supply through line 142 to the control valve 532. The fluid flows to the central spindle 534e between lands 534b and 534c to the first port 138a leading to the first line 106 and to the first chamber 102. The pressure of the fluid in the first chamber 102 in addition to any torsional energy moves the vane 104 in the direction of the arrow 553. At the same time, fluid exits the second chamber 103 through the second line 108 and through the second port 138b to the control valve 534 between spool lands 534a and 534b. From the control valve 534, the fluid exits through second exhaust line 508 to sump. It should be noted that fluid is blocked from exiting the first line 106 to the first exhaust line 506 by spool land 534c.

With the lock pin 120 in fluid communication with the second line 108, and fluid exiting the second chamber 103 is exhausted to sump, the pressure in the second line is not greater than the force of the lock pin spring 121 and the lock pin 120 engages the recess 127, locking the rotor assembly 105 relative to the housing assembly 107.

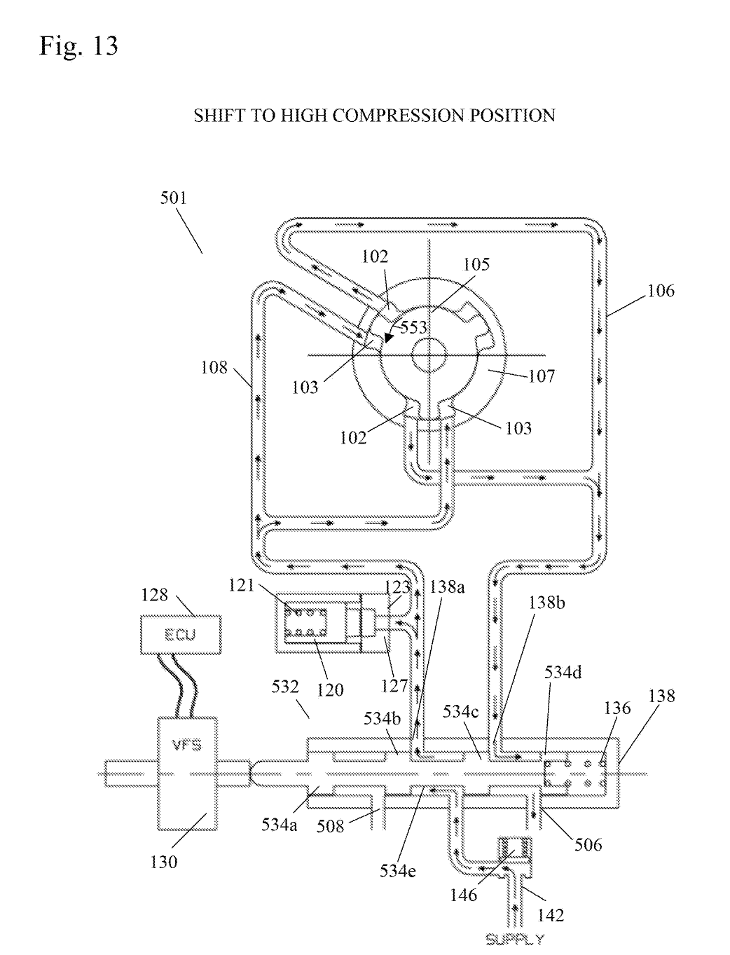

FIG. 13 shows the actuator 501 shifting towards the high compression position associated with a second compression ratio. To shift towards the high compression position, the force of the spring 136 is greater than the force of the VFS 130 and the spring 136 moves the spool 534 to the left in the figure until the force of the spring 136 balances the force of the spring 136. In the high compression position shown, fluid is supplied from supply through line 142 to the control valve 532. The fluid flows to the central spindle 534e between lands 534b and 534c and to the second port 138b leading to the second line 108 and to the second chamber 103. The pressure of the fluid in the second chamber 103 in addition to any torsional energy moves the vane 104 in the direction of the arrow 553. At the same time, fluid exits the first chamber 102 through the first line 106 through the first port 138a to the control valve 534 between spool lands 534c and 534d. From the control valve 534, the fluid exits through first exhaust line 506 to sump. It should be noted that fluid is blocked from exiting the second line 108 to the second exhaust line 506 by spool land 534b.

With the lock pin 120 in fluid communication with the second line 108, and fluid being supplied to the second chamber 103 by supply, the pressure in the second line 108 is greater than the force of the lock pin spring 121 and the lock pin 120 disengages the recess 127, allowing free movement of the rotor assembly 105 relative to the housing assembly 107.

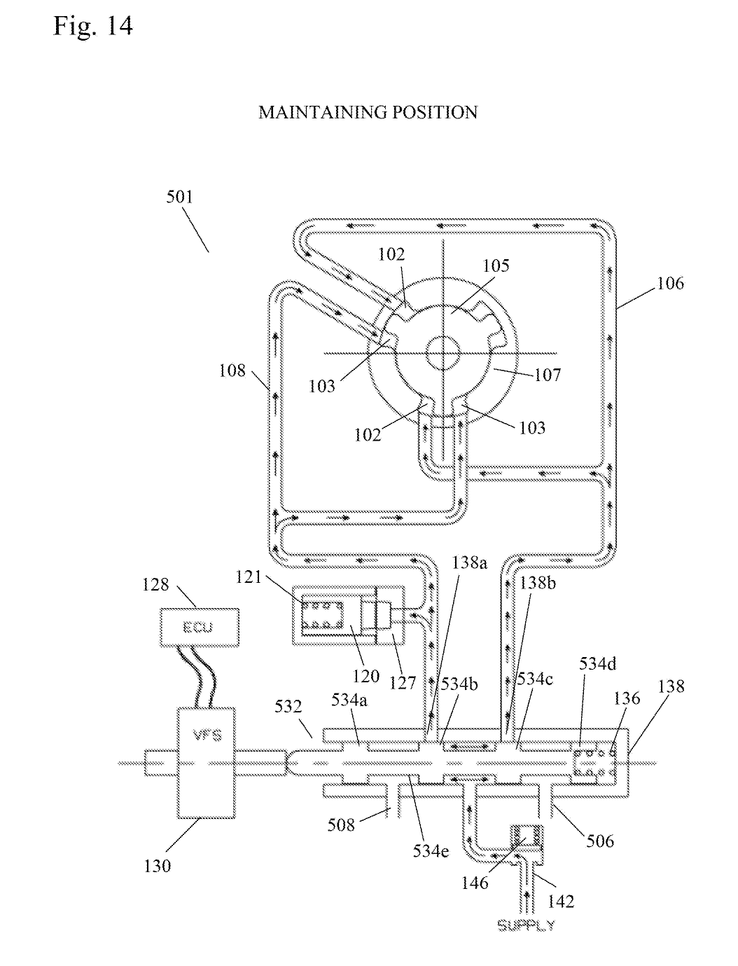

FIG. 14 shows the actuator 501 maintaining position. To maintain position, the force of the VFS 130 is equal to or balances the force of the spring 136. It should be noted that fluid is blocked from exiting the first line 106 to the first exhaust line 506 by spool land 534c and that fluid is blocked from exiting the second line 108 to the second exhaust line 508 by spool land 534b.

With the lock pin 120 in fluid communication with the second line 108, and fluid being supplied to the second chamber 103 by supply, the pressure in the second line 108 is greater than the force of the lock pin spring 121 and the lock pin 120 disengages the recess 127, allowing free movement of the rotor assembly 105 relative to the housing assembly 107.

It should be noted that while the only embodiment that shows the control valve, check valves, lines to the first and second chambers, ECU, and VFS as being remotely located from the actuators, any of the embodiments may have a control box 250 similar to that shown in FIG. 4 that contains a control valve, lines to the first and second chambers, check valves, EFS and VFS located remotely from the actuator without departing in scope from the invention.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. An actuator for an internal combustion engine having a variable compression ratio device with a control shaft, wherein the compression ratio of the engine is varied by rotary motion of the control shaft of the device, combustion impulses from the engine imparting torsional energy to the control shaft, the actuator comprising:
a housing assembly mounted to the engine;
a rotor assembly coupled to the control shaft, coaxially located within the housing assembly, the housing assembly and the rotor assembly defining at least one vane separating a chamber in the housing assembly into a first chamber and a second chamber, the vane being capable of rotation to shift the relative angular position of the housing assembly and the rotor assembly from a first rotational position associated with a first compression ratio to a second rotational position associated with a second compression ratio;
a control valve comprising a spool slidably mounted within a bore, the spool having at least two lands separated by a central spindle, and a plurality of check valves;
the actuator having a first passage coupling the first chamber to a first port in the bore, and a second passage coupling the second chamber to a second port in the bore,
such that when the spool is in a first position the lands of the spool allow fluid flow from the first port to the bore surrounding the central spindle, and torsional energy from the control shaft is permitted to rotate the rotor assembly in a direction from the first rotational position toward the second rotational position, causing fluid from the first chamber to flow through the first passage and the first port, through the bore surrounding the central spindle of the control valve and through the second port to the second passage to the second chamber, a first check valve being arranged to prevent fluid flow in a reverse direction; and
such that when the spool is in a second position the lands of the spool allow fluid flow from the second port to the bore surrounding the central spindle, and torsional energy from the control shaft is permitted to rotate the rotor assembly in a direction from the second rotational position toward the first rotational position, causing fluid from the second chamber to flow through the second passage and the second port, through the bore surrounding the central spindle of the control valve and through the first port to the first passage to the first chamber, a second check valve being arranged to prevent fluid flow in a reverse direction;
wherein when the spool is in the third position, the passage from the first chamber to the port in the spool is blocked by the second check valve within the control valve and the passage from the second chamber to the port in the control valve is blocked by the first check valve within the control valve.

2. The actuator of claim 1, wherein the plurality of check valves are located within the at least two lands of the spool.

3. The actuator of claim 1, wherein the first check valve and the second check valve are located remotely from the actuator.

4. The actuator of claim 1, further comprising a lock pin slidably mounted in a recess in one of the housing assembly or the rotor assembly, biased by a spring toward a mating recess in the other of the rotor assembly or the housing assembly, the lock pin being movable from a locked position in which the lock pin is in the mating recess, locking the rotor assembly to the housing assembly, and an unlocked position in which the lock pin is not in the mating recess and the rotor assembly is free to move relative to the housing assembly.

5. The actuator of claim 1, wherein the bore that receives the control valve is in the rotor assembly.

6. The actuator of claim 1, wherein the control valve is located remotely from the actuator.

7. The actuator of claim 1, wherein the rotor assembly further defines an oil pressure actuated third chamber and a fourth chamber;
such that when the spool is in a first position, the lands of the spool allow fluid flow from the first port to the bore surrounding the central spindle, and torsional energy from the control shaft is permitted to rotate the rotor assembly in a direction from the first rotational position toward the second rotational position, causing fluid a supply to flow through the control valve to the third chamber and fluid to exit to sump from the fourth chamber;
such that when the spool is in the second position, the lands of the spool allow fluid flow from the second port to the bore surrounding the central spindle, and torsional energy from the control shaft is permitted to rotate the rotor assembly in a direction from the second rotational position toward the first rotational position, causing fluid in the third chamber and the fourth chamber to exit to sump; and
wherein when the spool is in the third position, the passage from the first chamber to the port in the spool is blocked by the second check valve within the control valve and the passage from the second chamber to the port in the control valve is blocked by the first check valve within the control valve and fluid flows from supply to the third chamber.

8. An actuator for an internal combustion engine having a variable compression ratio device with a control shaft, wherein the compression ratio of the engine is varied by rotary motion of the control shaft of the device, combustion impulses from the engine imparting torsional energy to the control shaft, the actuator comprising:
a housing assembly mounted to the engine;
a rotor assembly coupled to the control shaft, coaxially located within the housing assembly, the housing assembly and the rotor assembly defining at least one vane separating a chamber in the housing assembly into a first chamber and a second chamber, the vane being capable of rotation to shift the relative angular position of the housing assembly and the rotor assembly from a first rotational position associated with a first compression ratio to a second rotational position associated with a second compression ratio;
a control valve comprising a spool slidably mounted within a bore, the spool having at least two lands separated by a central spindle;
the actuator having a first passage coupling the first chamber to a first port in the bore, and a second passage coupling the second chamber to a second port in the bore,
such that when the spool is in a first position the lands of the spool allow fluid flow from the first port to the bore surrounding the central spindle, and torsional energy from the control shaft is permitted to rotate the rotor assembly in a direction from the first rotational position toward the second rotational position, causing fluid from the first chamber to flow through the first passage and the first port, through the bore surrounding the central spindle of the control valve and to an exhaust line to sump and causing fluid from supply to through the bore surrounding the central spindle of the control valve and flow through the second passage and the second port to the second chamber;
such that when the spool is in a second position the lands of the spool allow fluid flow from the second port to the bore surrounding the central spindle, and torsional energy from the control shaft is permitted to rotate the rotor assembly in a direction from the second rotational position toward the first rotational position, causing fluid from the second chamber to flow through the second passage and the second port, through the bore surrounding the central spindle of the control valve and to an exhaust line to sump and causing fluid from supply to through the bore surrounding the central spindle of the control valve and flow through the first passage and the first port to the first chamber; and
wherein when the spool is in the third position, the passage from the first chamber to the port in the spool is blocked by the land and the passage from the second chamber to the port in the control valve is blocked by the land within the control valve.

9. The actuator of claim 8 further comprising a check valve between supply and the control valve to prevent flow of fluid in a reverse direction from the control valve to supply.

10. An actuator for an internal combustion engine having a variable compression ratio device with a control shaft, wherein the compression ratio of the engine is varied by rotary motion of the control shaft of the device, combustion impulses from the engine imparting torsional energy to the control shaft, the actuator comprising:
a housing assembly mounted to the engine;
a rotor assembly coupled to the control shaft, coaxially located within the housing assembly, the housing assembly and the rotor assembly defining at least one vane separating a chamber in the housing assembly into a first chamber and a second chamber, the vane being capable of rotation to shift the relative angular position of the housing assembly and the rotor assembly from a first rotational position associated with a first compression ratio to a second rotational position associated with a second compression ratio;
a control valve comprising a spool slidably mounted within a bore, the spool having at least two lands separated by a central spindle, and a plurality of check valves;
the actuator having a first passage coupling the first chamber to a first port in the bore, a second passage coupling the second chamber to a second port in the bore, and a common passage coupled to first passage and the second passage and to a common port in the bore;
such that when the spool is in a first position the lands of the spool allow fluid flow from the first port to the bore surrounding the central spindle, and torsional energy from the control shaft is permitted to rotate the rotor assembly in a direction from the first rotational position toward the second rotational position, causing fluid from the first chamber to flow through the first passage and the first port, through the bore surrounding the central spindle of the control valve through the common port and common line and through the second passage to the second chamber, a first check valve between the common line and the first line being arranged to prevent fluid flow in a reverse direction; and
such that when the spool is in a second position the lands of the spool allow fluid flow from the second port to the bore surrounding the central spindle, and torsional energy from the control shaft is permitted to rotate the rotor assembly in a direction from the second rotational position toward the first rotational position, causing fluid from the second chamber to flow through the second passage and the second port, through the bore surrounding the central spindle of the control valve through the common port and common line and through the first passage to the first chamber, a second check valve between the common line and the second line being arranged to prevent fluid flow in a reverse direction;
wherein when the spool is in the third position, the passage from the first chamber to the port in the spool is blocked by the second check valve within the control valve and the passage from the second chamber to the port in the control valve is blocked by the first check valve within the control valve.

11. The actuator of claim 10, wherein the plurality of check valves are located within the at least two lands of the spool.

12. The actuator of claim 10, wherein the first check valve and the second check valve are located remotely from the actuator.

13. The actuator of claim 10, further comprising a lock pin slidably mounted in a recess in one of the housing assembly or the rotor assembly, biased by a spring toward a mating recess in the other of the rotor assembly or the housing assembly, the lock pin being movable from a locked position in which the lock pin is in the mating recess, locking the rotor assembly to the housing assembly, and an unlocked position in which the lock pin is not in the mating recess and the rotor assembly is free to move relative to the housing assembly.

14. The actuator of claim 10, wherein the bore that receives the control valve is in the rotor assembly.

15. The actuator of claim 10, wherein the control valve is located remotely from the actuator.
